(19) United States
(12) Patent Application Publication
(10) Pub. No.: US 2002/0163590 A1
(43) Pub. Date: Nov. 7, 2002

(54) Video signal conversion method

(76) Inventor: Chung-Chih Tung, Taipei (TW)

Correspondence Address: BIRCH STEWART KOLASCH & BIRCH, PO BOX 747, FALLS CHURCH, VA, 22040-0747, US

(21) Appl. No.: 09/848,376

(22) Filed: May 4, 2001

(51) Int. Cl. H04N 5/44; H04N 3/27

(52) U.S. Cl. 348/554; 348/553

(57) ABSTRACT

The invention discloses a video signal conversion method, which uses the BIOS to determine whether the purpose that the user turns on the machine is for watching the TV or for usual computer operations before an OS is loaded. When the user wants to watch the TV, the BIOS directly control a Video tuner chip, a video capture chip, a VGA chip to perform video signal tuning, capture and control. Finally, the BIOS drives a display to show the video signals in visible images. Through the disclosed video signal conversion method, the video signal conversion operation of using a computer to watch TV becomes closer to a conventional TV. This does not only simplify the operation procedure but also saves a lot of time in waiting for an OS to be loaded in as in the prior art.

### BACKGROUND OF THE INVENTION

1. Field of Invention

The invention pertains to a video signal conversion method and, in particular, to a video signal conversion method that can use a computer to watch TV without entering any OS.

2. Related Art

As multimedia and the Internet become more popular and there are a lot of accompanying applications, the functions of computers are not limited to conventional program computing or word processing. They have gradually come into our daily life and become an indispensable tool. In particular, young students or adolescents living on their own tend to use computer to replace the functions of the TV and VCR, saving the expenses in home electronics.

The traditional method of using computers to watch TV needs an external TV Card in addition to a VGA card that is already installed in the computer. With reference to FIG. 1, the TV Card 20 also includes a TV tuner unit 21 and a video capture unit 22. A cable TV cable 10 connects to the TV tuner unit 21 of the TV Card 20. After the TV tuner unit 21 demodulates the video signal V transmitted by the cable TV, the video capture unit 22 captures a capture signal C, which is then turned into a visible image on a display 40 driven by the VGA card 30 installed in the computer.

Since in the above method the TV tuner unit 21, the video capture unit 22, the VGA card 30 and the display 40 have to be controlled by an OS, the user is forced to load in an OS such as Windows or OS2 before he can use the computer to watch TV. In comparison with the conventional procedure for watching TV, this method wastes a lot of time in waiting the loading of the OS and is extremely inconvenient.

### SUMMARY OF THE INVENTION

In view of the foregoing problem of waiting too much time in order to watch TV, the invention discloses a video signal conversion method that enables a mainboard to control a Video tuner chip, a video capture chip, a VGA chip, and a display to convert video signals before a computer is installed with or has loaded in any OS. This video signal conversion operation is closer to the traditional TV operation procedure and does not require waiting.

To achieve the object, the disclosed method includes the steps of: obtaining a power on signal, obtaining a video signal when the power on signal is a TV selection signal, capturing the video signal, and driving a display to turn the video signal into a visible image.

### BRIEF DESCRIPTION OF THE DRAWINGS

The present invention will become more fully understood from the detailed description given hereinbelow illustration only, and thus are not limitative of the present invention, and wherein:

FIG. 1 is a functional block diagram of a conventional video signal conversion method;

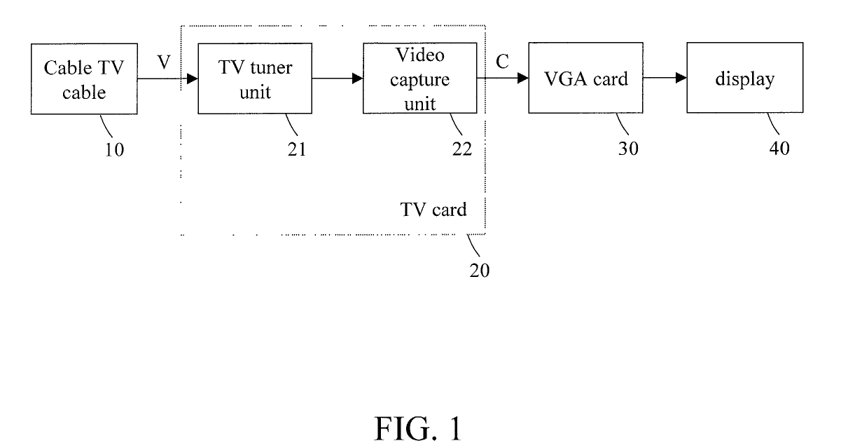

FIG. 2A is a flowchart of the disclosed video signal conversion method;

FIG. 2B is the continued flowchart from FIG. 2A; and

FIG. 3 shows a functional block diagram of the disclosed video signal conversion method.

### DETAILED DESCRIPTION OF THE INVENTION

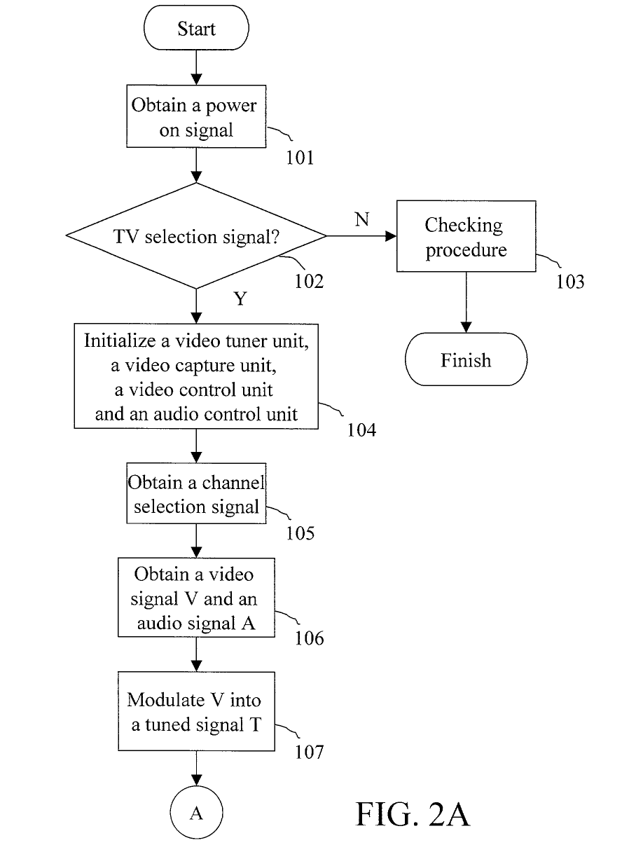

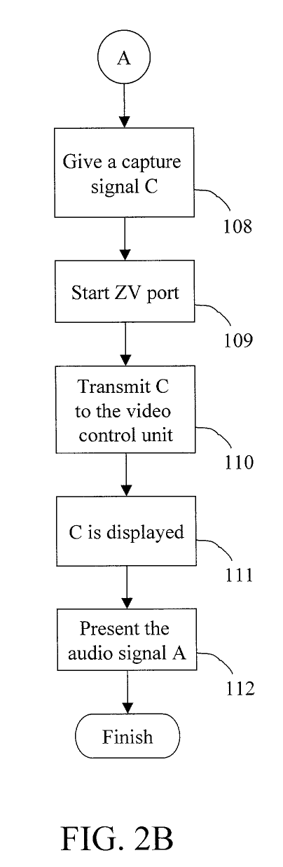

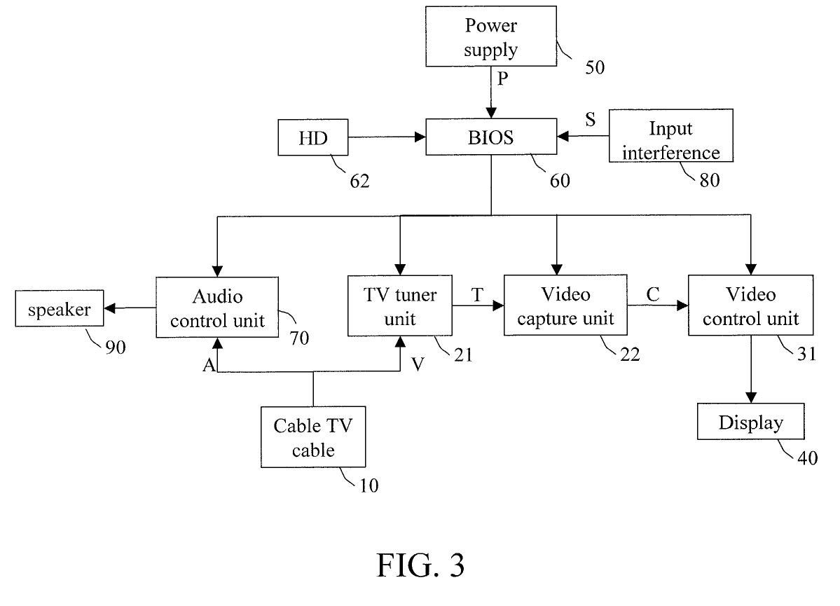

Please refer to FIGS. 2A, 2B, and 3 for the flowchart and the functional block diagram of the video signal conversion method. First, a power supply obtains a power on signal P, meaning the computer power has been initialized (step 101). The computer referred herein can be a PC (personal computer) or a notebook computer. Secondly, the BIOS (Basic Input Output System) 60 determines whether the power on signal P is a TV selection signal or an operation selection signal (step 102). When the power on signal P is an operation selection signal, the BIOS 60 then the computer executes a normal power on checking procedure and loads in an OS (Operating System) from a HDD (Hard Disk Drive) 62 (step 103). If the power on signal P is a TV selection signal, the computer initializes a video tuner unit 21, a video capture unit 22, a video control unit 31 and an audio control unit 70 (step 104). The video tuner unit 21 can be a TV tuner chip. The video capture unit 22 can be a video capture chip. The video control unit 31 can be a VGA chip. The audio control unit 70 can be an audio chip. A channel selection signal S is obtained from an input interface 80 (step 105). In accordance with the channel selection signal S, a video signal V and an audio signal A are obtained from a cable TV cable 10 (step 106). The video signal V is demodulated by the video tuner unit 21 into a tuned signal T (step 107). The video capture unit 22 then extracts the tuned signal T to give a capture signal C (step 108). A ZV port between the video capture unit 22 and the video control unit 31 is then started (step 109). Through the ZV port, the capture signal C is transmitted to the video control unit 31 (step 110). The capture signal C is displayed as a visible image on the display 40 driven by the video control unit 31 (step 111). Finally, the audio control unit 70 drives a speaker 90 to present the audio signal A (step 112).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A video signal conversion method for a computer that is not installed with or has not loaded in any OS (Operating System), which comprises the steps of:
obtaining a power on signal;
obtaining a channel selection signal when the power on signal is a TV selection signal;
obtaining a video signal according to the channel selection signal;
capturing the video signal; and
driving a display to turn the video signal into a visible image.

2. The method of claim 1 further comprising the step of loading in an OS when the power on signal is an operation selection signal.

3. The method of claim 1 further comprising the step of initializing a video control unit, a video tuner unit, and a video capture unit.

4. The method of claim 3, wherein the video control unit is a VGA chip.

5. The method of claim 3, wherein the video tuner unit is a video tuner chip.

6. The method of claim 3, wherein the video capture unit is a video capture chip.

7. The method of claim 3 further comprising the step of initializing an audio control unit.

8. The method of claim 7, wherein the audio control unit is an audio chip.

9. The method of claim 1, wherein the step of capturing the video signal further comprises the steps of:
demodulating the video signal into a tuned signal using the video tuner unit; and
capturing the tuned signal as a capture signal using the video capture unit.

10. The method of claim 1, wherein the step of driving a display to turn the video signal into a visible image further comprises the steps of turning the capture signal into a visible image using the video control unit.

11. The method of claim 10 further comprising the step of initializing a ZV port between the video capture unit and the video control unit.

12. The method of claim 1, wherein the computer is a notebook computer.

13. A video signal conversion method for a computer that is not installed with or has not loaded in any OS (Operating System), which comprises the steps of:
obtaining a power on signal;
initializing a VGA chip, a video tuner chip, and a video capture chip when the power on signal is a TV selection signal;
obtaining a channel selection signal;
obtaining a video signal according to the channel selection signal;
demodulating the video signal into a tuned signal using the video tuner chip;
capturing the tuned signal as a capture signal using the video capture chip; and
driving a display to turn the capture signal into a visible image using the VGA chip.

14. The method of claim 13 further comprising the step of loading in an OS when the power on signal is an operation selection signal.

15. The method of claim 13 further comprising the step of initializing an audio chip.

16. The method of claim 13, wherein the step of capturing the video signal comprising the step of:
initializing a ZV port between the video capture chip and the VGA chip; and
transmitting the capture signal to the VGA chip through the ZV port.

17. The method of claim 13, wherein the computer is a notebook computer.
